(19) United States
(12) Patent Application Publication
(10) Pub. No.: US 2025/0244861 A1
(43) Pub. Date: Jul. 31, 2025

(54) METHOD FOR MATERIAL EDITING, APPARATUS, ELECTRONIC DEVICE, AND COMPUTER-READABLE STORAGE MEDIUM

(71) Applicant: Beijing Zitiao Network Technology Co., Ltd., Haidian District (CN)

(72) Inventors: Jiahao Chen, Beijing (CN); Xinyi He, Beijing (CN); Mengji Zhou, Beijing (CN); Mingyuan Wang, Beijing (CN)

(21) Appl. No.: 19/041,775

(22) Filed: Jan. 30, 2025

(30) Foreign Application Priority Data
Jan. 31, 2024 (CN) 202410140009.6

(51) Int. Cl. G06F 3/04845

(52) U.S. Cl. CPC G06F 3/04845

(57) ABSTRACT

A method for material editing is provided, including: presenting a chat interface of a target chat in a first social application, the target chat used for operation management of a target service, members of the target chat including a material editing robot, at least one first user, and at least one second user, at least one material is presented in the chat interface, to indicate a process in which the first user provides the target service for a target object, which is an object related to the second user; presenting, in the chat interface, a material editing instruction for the target object sent by a user to the material editing robot; and presenting, in the chat interface, at least one material editing result replied and obtained by the material editing robot through performing editing on a target material in the at least one material based on the material editing instruction.

### CROSS-REFERENCE

This application claims priority to Chinese Patent Application No. 202410140009.6 filed on Jan. 31, 2024, and titled “METHOD FOR MATERIAL EDITING, APPARATUS, ELECTRONIC DEVICE, AND COMPUTER-READABLE STORAGE MEDIUM”.

### FIELD

The present disclosure relates to the field of image editing technologies, and in particular, to a method for material editing, an apparatus, an electronic device, and a computer-readable storage medium.

### BACKGROUND

At present, many service providers maintain a relationship with a buyer who accepts a service and market the service by creating a chat window with the buyer in a social application. However, at present, service providers mostly communicate and interact with the buyer by sending the buyer text information, voice information, a picture, a video, or the like. The text information and the voice information are boring, and it is difficult to attract attention of the buyer. The picture or the video sometimes makes it difficult to clearly express content that the service provider wants to express. To clearly express the content that the service provider wants to express, the service provider needs to spend a lot of time designing and imaging materials and performing material editing.

However, for most service providers, there is usually not a lot of time to design and image materials. Even if materials are imaged, due to a lack of material editing experience, a process of performing material editing on the materials is time-consuming, and quality of a material editing result is not high, resulting in poor maintenance and marketing effects of the chat window.

### SUMMARY

In order to solve the above technical problems or at least partially solve the above technical problems, the present disclosure provides a method for material editing, an apparatus, an electronic device, and a computer-readable storage medium.

According to a first aspect of embodiments of the present disclosure, there is provided a method for material editing. The method includes: presenting a chat interface of a target chat in a first social application, wherein the target chat is used for operation management of a target service, and members of the target chat comprise a material editing robot, at least one first user, and at least one second user, wherein at least one material is presented in the chat interface, the at least one material being used to indicate a process in which the first user provides the target service for a target object, and the target object is an object related to the second user; presenting, in the chat interface, a material editing instruction for the target object that is sent by a user to the material editing robot; and presenting, in the chat interface, at least one material editing result replied by the material editing robot, wherein the at least one material editing result is obtained by the material editing robot through performing editing on a target material in the at least one material based on the material editing instruction, and each material editing result is used to indicate a service process and a service effect of the target service for the target object.

In some embodiments of the present disclosure, the presenting, in the chat interface, at least one material editing result replied by the material editing robot comprises: presenting, in the chat interface, a plurality of images and first prompt information replied by the material editing robot, wherein the first prompt information is used to prompt the user to select, from the plurality of images, an image corresponding to the target object, and each image is an image that includes one object extracted by the material editing robot from the at least one material; and presenting the at least one material editing result in response to a triggering operation in which the user selects a target image corresponding to the target object.

In some embodiments of the present disclosure, the presenting, in the chat interface, at least one material editing result replied by the material editing robot comprises: presenting, in the chat interface, a target chat message replied by the material editing robot, wherein the target chat message comprises the at least one material editing result, and the target chat message further comprises at least one of the following: at least one operation identification or second prompt information; wherein each operation identification is used to indicate any one of the following: playing a target material editing result in the at least one material editing result, saving the target material editing result in the at least one material editing result, posting the target material editing result in the at least one material editing result to an information publication interface of a second social application, re-editing on the target material to generate the material editing result, and jumping to a video editing application to perform a secondary editing on the target material editing result in the at least one material editing result; and the second prompt information is used to prompt the user that the at least one material editing result has been generated.

In some embodiments of the present disclosure, after the presenting, in the chat interface, the target chat message replied by the material editing robot, the method further comprises: presenting, in the chat interface, a first chat message between the first user and the second user, wherein the first chat message comprises at least one of the following: a discussion message about an editing effect of the at least one material editing result; a discussion message about the target service based on the at least one material editing result; or a discussion message about posting the at least one material editing result to an information publication interface of a second social application.

In some embodiments of the present disclosure, after the presenting, in the chat interface, a target chat message replied by the material editing robot, the method further comprises: presenting third prompt information in the chat interface, wherein the third prompt information is used to indicate that a third user joins the target chat by using link information carried in the target material editing result posted by a second user on the information publication interface, wherein the target material editing result further carries at least one of the following: related text information of the target material editing result, location information corresponding to the target service, or service type information of the target service; and the link information is used to indicate a path for joining the target chat.

In some embodiments of the present disclosure, the third user has permission to view a historical chat record of the target chat; and after the presenting third prompt information in the chat interface, the method further comprises: presenting, in the chat interface, a second chat message between the third user and a fourth user, wherein the second chat message comprises: a discussion message about the target service based on the at least one material editing result, and the fourth user comprises any one of the following: the first user and the second user.

In some embodiments of the present disclosure, before the presenting third prompt information in the chat interface, the method further comprises: presenting fourth prompt information in the chat interface, wherein the fourth prompt information is used to indicate that the second user posts the target material editing result to the information publication interface.

In some embodiments of the present disclosure, the electronic device is an electronic device of the second user, and before the presenting third prompt information in the chat interface, the method further comprises: presenting an information confirmation interface in response to a triggering operation of the second user on a target operation identification in the at least one operation identification, wherein the information confirmation interface is used to confirm information carried in the target material editing result, and the target operation identification is used to indicate the posting of the target material editing result to the information publication interface; and presenting the target material editing result and the information carried in the target material editing result on the information publication interface in response to the triggering operation of the second user confirming to post the target material editing result.

In some embodiments of the present disclosure, after the presenting the target material editing result and the information carried in the target material editing result on the information publication interface in response to the triggering operation of the second user confirming to post the target material editing result, the method further comprises: presenting a first resource information interface, wherein the first resource information interface is used to present a resource obtained by the second user because of posting the target material editing result, and the first resource information interface comprises first resource information and second resource information, the first resource information is used to indicate a resource allocated to the second user because of a first-type user who joins the target chat by using the link information, and the second resource information is used to indicate a resource to be allocated to the second user because of a second-type user who joins the target chat by using the link information, wherein the first-type user is a user who has accepted the target service provided by the first user, and the second-type user is a user who has not accepted the target service provided by the first user.

In some embodiments of the present disclosure, the electronic device is an electronic device of the first user, and the method further comprises: presenting a second resource information interface, wherein the second resource information interface is used to present a resource obtained by performing operation management on the target service by using the target chat, and the second resource information interface comprises first resource information, second resource information, and third resource information; wherein the first resource information is used to indicate a resource allocated to the second user because of a first-type user who joins the target chat by using the link information, the second resource information is used to indicate a resource to be allocated to the second user because of a second-type user who joins the target chat by using the link information, and the third resource information is used to indicate a resource obtained by providing the target service for the first-type user who joins the target chat by using the link information, wherein the first-type user is a user who has accepted the target service provided by the first user, and the second-type user is a user who has not accepted the target service provided by the first user.

In some embodiments of the present disclosure, before the presenting, the chat interface of the target chat in the first social application, the method further comprises: presenting a function setting interface of the material editing robot in response to a triggering operation in which the first user adds the material editing robot to the target chat; and in response to a triggering operation of the first user on the function setting interface, presenting a chat message sent by the material editing robot in the chat interface; wherein the chat message comprises a function introduction of the material editing robot in text form, and the chat message further comprises at least one of the following: a function introduction of the material editing robot in video format; or a question from the material editing robot on a chat topic of the chat interface.

According to a second aspect of embodiments of the present disclosure, there is provided an apparatus for material editing. The apparatus includes: a presenting module configured to present a chat interface of a target chat in a first social application, wherein the target chat is used for operation management of a target service, and members of the target chat comprise a material editing robot, at least one first user, and at least one second user, wherein at least one material is presented in the chat interface, the at least one material being used to indicate a process in which the first user provides the target service for a target object, and the target object is an object related to the second user; present, in the chat interface, a material editing instruction for the target object that is sent by a user to the material editing robot; and present, in the chat interface, at least one material editing result replied by the material editing robot, wherein the at least one material editing result is obtained by the material editing robot through performing editing on a target material in the at least one material based on the material editing instruction, and each material editing result is used to indicate a service process and a service effect of the target service for the target object.

In some embodiments of the present disclosure, the presenting module is specifically configured to present, in the chat interface, a plurality of images and first prompt information replied by the material editing robot, wherein the first prompt information is used to prompt the user to select, from the plurality of images, an image corresponding to the target object, and each image is an image that includes one object extracted by the material editing robot from the at least one material; and present the at least one material editing result in response to a triggering operation in which the user selects a target image corresponding to the target object.

In some embodiments of the present disclosure, the presenting module is specifically configured to present, in the chat interface, a target chat message replied by the material editing robot, wherein the target chat message comprises the at least one material editing result, and the target chat message further comprises at least one of the following: at least one operation identification or second prompt information; wherein each operation identification is used to indicate any one of the following: playing a target material editing result in the at least one material editing result, saving the target material editing result in the at least one material editing result, posting the target material editing result in the at least one material editing result to an information publication interface of a second social application, re-editing on the target material to generate the material editing result, and jumping to a video editing application to perform a secondary editing on the target material editing result in the at least one material editing result; and the second prompt information is used to prompt the user that the at least one material editing result has been generated.

In some embodiments of the present disclosure, the presenting module is further configured to present, in the chat interface, a first chat message between the first user and the second user, wherein the first chat message comprises at least one of the following: a discussion message about an editing effect of the at least one material editing result; a discussion message about the target service based on the at least one material editing result; or a discussion message about posting the at least one material editing result to an information publication interface of a second social application.

In some embodiments of the present disclosure, the presenting module is further configured to present third prompt information in the chat interface, wherein the third prompt information is used to indicate that a third user joins the target chat by using link information carried in the target material editing result posted by a second user on the information publication interface, wherein the target material editing result further carries at least one of the following: related text information of the target material editing result, location information corresponding to the target service, or service type information of the target service; and the link information is used to indicate a path for joining the target chat.

In some embodiments of the present disclosure, the third user has permission to view a historical chat record of the target chat; and the presenting module is further configured to present, in the chat interface, a second chat message between the third user and a fourth user, wherein the second chat message comprises: a discussion message about the target service based on the at least one material editing result, and the fourth user comprises any one of the following: the first user and the second user.

In some embodiments of the present disclosure, the presenting module is further configured to present fourth prompt information in the chat interface, wherein the fourth prompt information is used to indicate that the second user posts the target material editing result to the information publication interface.

In some embodiments of the present disclosure, the electronic device is an electronic device of the second user, and the presenting module is further configured to present an information confirmation interface in response to a triggering operation of the second user on a target operation identification in the at least one operation identification, wherein the information confirmation interface is used to confirm information carried in the target material editing result, and the target operation identification is used to indicate the posting of the target material editing result to the information publication interface; and present the target material editing result and the information carried in the target material editing result on the information publication interface in response to the triggering operation of the second user confirming to post the target material editing result.

In some embodiments of the present disclosure, the presenting module is further configured to present a first resource information interface, wherein the first resource information interface is used to present a resource obtained by the second user because of posting the target material editing result, and the first resource information interface comprises first resource information and second resource information, the first resource information is used to indicate a resource allocated to the second user because of a first-type user who joins the target chat by using the link information, and the second resource information is used to indicate a resource to be allocated to the second user because of a second-type user who joins the target chat by using the link information, wherein the first-type user is a user who has accepted the target service provided by the first user, and the second-type user is a user who has not accepted the target service provided by the first user.

In some embodiments of the present disclosure, the electronic device is an electronic device of the first user, and the presenting module is further configured to present a second resource information interface, wherein the second resource information interface is used to present a resource obtained by performing operation management on the target service by using the target chat, and the second resource information interface comprises first resource information, second resource information, and third resource information; wherein the first resource information is used to indicate a resource allocated to the second user because of a first-type user who joins the target chat by using the link information, the second resource information is used to indicate a resource to be allocated to the second user because of a second-type user who joins the target chat by using the link information, and the third resource information is used to indicate a resource obtained by providing the target service for the first-type user who joins the target chat by using the link information, wherein the first-type user is a user who has accepted the target service provided by the first user, and the second-type user is a user who has not accepted the target service provided by the first user.

In some embodiments of the present disclosure, the presenting module is further configured to present a function setting interface of the material editing robot in response to a triggering operation in which the first user adds the material editing robot to the target chat; and in response to a triggering operation of the first user on the function setting interface, presenting a chat message sent by the material editing robot in the chat interface; wherein the chat message comprises a function introduction of the material editing robot in text form, and the chat message further comprises at least one of the following: a function introduction of the material editing robot in video format; or a question from the material editing robot on a chat topic of the chat interface.

According to a third aspect of embodiments of the present disclosure, there is provided an electronic device. The electronic device includes a processor, a memory, and a computer program stored in the memory that, when executed by the processor, causes the processor to implement the method for material editing according to the first aspect.

According to a fourth aspect of embodiments of the present disclosure, there is provided a computer-readable storage medium having a computer program stored thereon that, when executed by a processor, implements the method for material editing according to the first aspect.

According to a fifth aspect of embodiments of the present disclosure, there is provided a computer program product, where the computer program product includes a computer program that, when the computer program product runs on a processor, causes the processor to execute the computer program, to implement the method for material editing according to the first aspect.

According to a sixth aspect of embodiments of the present disclosure, there is provided a chip, where the chip includes a processor and a communication interface, the communication interface is coupled to the processor, and the processor is configured to run program instructions, to implement the method for material editing according to the first aspect.

Compared with the prior art, the technical solution provided in this embodiment of the present disclosure has the following advantages. A chat interface of a target chat is presented in a first social application, wherein the target chat is used for operation management of a target service, and members of the target chat comprise a material editing robot, at least one first user, and at least one second user, wherein at least one material is presented in the chat interface, the at least one material being used to indicate a process in which the first user provides the target service for a target object, and the target object is an object related to the second user; in the chat interface, a material editing instruction for the target object that is sent by a user to the material editing robot is presented; and in the chat interface, at least one material editing result replied by the material editing robot is presented, wherein the at least one material editing result is obtained by the material editing robot through performing editing on a target material in the at least one material based on the material editing instruction, and each material editing result is used to indicate a service process and a service effect of the target service for the target object. In this solution, the material editing robot with a material editing function is added to the target chat, so that the user can send the material editing instruction to the material editing robot, to enable the material editing robot to perform editing on the target material in the at least one material based on the material editing instruction, to obtain the at least one material editing result, and present the at least one material editing result replied by the material editing robot in the chat interface. In this way, the user does not need to spend a lot of time designing and imaging materials and can obtain at least one material only by imaging a material of an actual process of providing a service for the user. When the at least one material is edited, the user does not need to perform a series of complicated material editing operations to generate the material editing result but only needs to send the imaged at least one material to the target chat, and the material editing robot edits the at least one material to obtain the at least one material editing result. In this way, efficiency and quality of material editing can be improved, and the material editing result obtained by performing material editing on the material of the real process in which the user accepts the target service in the target chat can be used to make a user communicate and interact with other users in the target chat, so that the target chat can be better maintained, and the target service can be better marketed.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

In order to more clearly describe the technical solutions in the embodiments of the present disclosure or in the prior art, the following briefly describes the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic flowchart of a method for material editing according to an embodiment of the present disclosure;

FIG. 2 is a schematic diagram of an interface illustrating the method for material editing according to an embodiment of the present disclosure;

FIG. 3 is a schematic diagram of an interface illustrating the method for material editing according to an embodiment of the present disclosure;

FIG. 4 is a schematic diagram of an interface illustrating the method for material editing according to an embodiment of the present disclosure;

FIG. 5 is a schematic diagram of an interface illustrating the method for material editing according to an embodiment of the present disclosure;

FIG. 6 is a block diagram of a structure of an apparatus for material editing according to an embodiment of the present disclosure; and

FIG. 7 is a block diagram of a structure of an electronic device according to an embodiment of the present disclosure.

### DETAILED DESCRIPTION

In order to more clearly understand the above objectives, features, and advantages of the present disclosure, the following further describes the solutions of the present disclosure. It should be noted that the embodiments of the present disclosure and the features in the embodiments may be combined with each other when there is no conflict.

In the following description, many specific details are set forth to fully understand the present disclosure, but the present disclosure may also be implemented in other manners different from those described herein. It is apparent that the embodiments in the specification are only some embodiments of the present disclosure, rather than all of the embodiments.

The terms “first” and “second” in the specification, claims, and accompanying drawings of the present disclosure are intended to distinguish between similar objects, but do not necessarily indicate a specific order or sequence. It should be understood that the data termed in such a way are interchangeable in proper circumstances so that the embodiments of the present disclosure can be implemented in orders except for the order illustrated or described herein. Moreover, the objects distinguished by “first”, “second”, and the like are usually a category, and do not limit the number of the objects. For example, the first object may be one or more than one. In addition, “and/or” in the specification and the claims indicates at least one of the connected objects. The character “/” generally indicates an “or” relationship between the associated objects.

The electronic device in the embodiments of the present disclosure may be a mobile electronic device or a non-mobile electronic device. The mobile electronic device may be a mobile phone, a tablet computer, a notebook computer, a palmtop computer, an in-vehicle electronic device, a wearable device, an ultra-mobile personal computer (UMPC), a netbook, or a personal digital assistant (PDA). The non-mobile electronic device may be a personal computer (PC), a television (TV), a teller machine, or a self-service machine. This is not specifically limited in the embodiments of the present disclosure.

An execution body of the method for material editing provided in the embodiments of the present disclosure may be the foregoing electronic device (including the mobile electronic device and the non-mobile electronic device) or may be a functional module and/or a functional entity in the electronic device that can implement the method for material editing. The specific execution body may be determined based on an actual use requirement and is not limited in the embodiments of the present disclosure.

The following describes the method for material editing provided in the embodiments of the present disclosure in detail with reference to the accompanying drawings and through specific embodiments and application scenarios thereof.

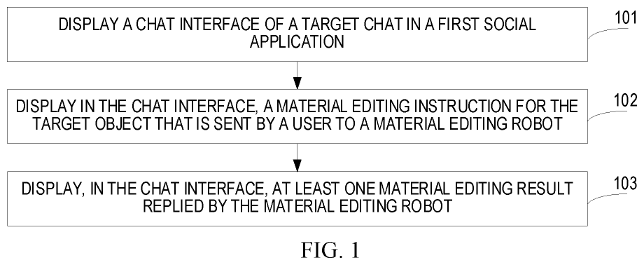

As shown in FIG. 1, an embodiment of the present disclosure provides a method for material editing, which may include the following steps 101 to 103.

101: Present a chat interface of a target chat in a first social application.

The target chat is used for operation management of a target service, and members of the target chat include a material editing robot, at least one first user, and at least one second user. At least one material is presented in the chat interface, the at least one material being used to indicate a process in which the first user provides the target service for a target object, and the target object is an object related to the second user.

The target service may be any life service, for example, a service type such as hair care, beauty care, catering, pet boarding, and pet grooming. The specific service type may be determined based on an actual situation, which is not limited here.

The first user is a merchant user who provides the target service, and the second user is a buyer user who accepts the target service.

Members of the target chat may further include other users who have the same attribute as the second user. The specific users may be determined based on an actual situation, which is not limited here.

The target object may be the second user, a pet of the second user, a relative of the second user, or the like. The specific object may be determined based on an actual situation, which is not limited here.

The first user may operate and market the target service by communicating and interacting with the second user and the editing robot in the target chat, to implement operation management on the target service.

The first social application may be any instant social application. The specific application may be determined based on an actual situation, which is not limited here.

In some embodiments of the present disclosure, the material editing robot is a software development kit (SDK) that integrates a material editing processing capability and that is presented in a chat interface in a form of a robot.

In some embodiments of the present disclosure, the SDK may be installed in a backend server of the first social application or another server associated with the backend server of the first social application. The specific server may be determined based on an actual situation, which is not limited here. In this case, any user in the target chat may chat with the material editing robot.

In some embodiments of the present disclosure, the SDK may be installed in a backend server of a version of the first social application on a target service providing side (that is, a merchant version of the first social application) or another server associated with the backend server of the version of the first social application on the target service providing side. The specific server may be determined based on an actual situation, which is not limited here. In this case, only the first user who installs the version of the first social application on the target service providing side in the target chat can chat with the material editing robot.

102: Present, in the chat interface, a material editing instruction for the target object that is sent by a user to the material editing robot.

The user who sends the material editing instruction may be any first user, the second user, or another user. The specific user may be determined based on an actual situation, which is not limited here.

The material editing instruction may be an instruction in a voice form or an instruction in a text form. The specific form of the instruction may be determined based on an actual situation, which is not limited here.

For example, the material editing instruction may specifically be “@Material editing robot, can you edit a video of implementing the target service for the target object?”, “@Material editing robot, edit a promotional video of implementing the target service for the target object”, “@Material editing robot, edit a promotional video of implementing the target service for the target object. Do not forget to apply beautification filter on the target object!” or the like. The specific content of the instruction may be determined based on an actual situation, which is not limited here.

103: Present, in the chat interface, at least one material editing result replied by the material editing robot.

The at least one material editing result is obtained by the material editing robot through performing editing on a target material in the at least one material based on the material editing instruction, and each material editing result is used to indicate a service process and a service effect of the target service for the target object.

The target material may be some materials or all materials in the at least one material. The specific materials may be determined based on an actual situation, which is not limited here.

A specific process of performing editing on the target material in the at least one material may refer to related technologies, and details are not described herein again.

In some embodiments of the present disclosure, in response to the material editing instruction, the material editing robot determines, from the at least one material, at least one candidate material including the target object, and then performs material editing on the target material in the at least one candidate material to obtain the at least one material editing result.

In some embodiments of the present disclosure, if the material editing robot previously stores image information about the target object, the material editing robot directly screens the at least one material based on the stored image information of the target object, to screen out the at least one candidate material including the target object.

In some embodiments of the present disclosure, if the material editing robot does not previously store image information of the target object, the material editing robot first extracts an image of each object that has the same type as the target object from the at least one material and then presents the image of each object for the user to select.

In some embodiments of the present disclosure, after determining the at least one candidate material from the at least one material, the material editing robot may further present, in the chat interface, the at least one candidate material and material selection prompt information sent by the material editing robot, where the material selection prompt information is used to prompt the user to select, from the at least one candidate material, a material that needs to be edited; and then in response to a triggering in which the user selects the target material from the at least one candidate material, the material editing robot performs editing on the target material to obtain the at least one material editing result.

For example, if the target service is hair care, the service process is a hair care process, and the service effect is a hair care effect, that is, a hairstyle after the second user has the hair cared. The at least one material editing result is used to present the hair care process in which the second user accepts the hair care service and the hairstyle after the hair care ends.

For example, if the target service is beauty care, the service process is a beauty care process, and the service effect is a beauty care effect, that is, a facial improvement effect after the second user has the beauty care. The at least one material editing result is used to present the beauty care process in which the second user accepts the beauty care service and the facial improvement effect after the beauty care ends.

In the embodiments of the present disclosure, the material editing robot with a material editing function is added to the target chat, so that the user can send the material editing instruction to the material editing robot, to enable the material editing robot to perform editing on the target material in the at least one material based on the material editing instruction, to obtain the at least one material editing result, and present the at least one material editing result replied by the material editing robot in the chat interface. In this way, the user does not need to spend a lot of time designing and imaging materials and can obtain at least one material only by imaging a material of an actual process of providing a service for the user. When the at least one material is edited, the user does not need to perform a series of complicated material editing operations to generate the material editing result but only needs to send the imaged at least one material to the target chat, and the material editing robot edits the at least one material to obtain the at least one material editing result. In this way, efficiency and quality of material editing can be improved, and the material editing result obtained by performing material editing on the material of the real process of the user accepting the target service in the target chat can be used to make a user communicate and interact with other users in the target chat, so that the target chat can be better maintained, and the target service can be better marketed.

In some embodiments of the present disclosure, the at least one material editing result is presented in the chat interface, so that the user can select a satisfactory material editing result from the at least one material editing result.

In some embodiments of the present disclosure, step 103 may be specifically implemented by the following steps 103a and 103b.

103a: Present, in the chat interface, a plurality of images and first prompt information replied by the material editing robot.

The first prompt information is used to prompt the user to select, from the plurality of images, an image corresponding to the target object, and each image is an image that includes one object extracted by the material editing robot from the at least one material.

For example, the content of the first prompt information may be “Which one is the target object?”, “Please select the target object?” or the like. The specific content may be determined based on an actual situation, which is not limited here.

103b: Present the at least one material editing result in response to a triggering in which the user selects a target image corresponding to the target object.

In the embodiments of the present disclosure, the foregoing steps 103a and 103b can ensure that the at least one material editing result is focused on the target object and can increase interaction between the user and the material editing robot, thereby improving the user experience.

In some embodiments of the present disclosure, in a process of executing the material editing instruction, the material editing robot may apply beautification filter on the target object by default regardless of whether the material editing instruction includes a beautification related instruction, determine whether to apply beautification filter on the target object based on whether the material editing instruction includes the beautification related instruction, or present, in the chat interface, a chat message in which the material editing robot asks whether to apply beautification filter on the target object when the material editing instruction does not include the beautification related instruction, and then determine whether to apply beautification filter on the target object based on a reply of the user. The specific manner may be determined based on an actual situation, which is not limited here.

In some embodiments of the present disclosure, when the material editing instruction includes the beautification related instruction, in response to the beautification related instruction, at least one beautification processing result replied by the material editing robot is presented in the chat interface (the at least one beautification processing result is obtained by the material editing robot through applying beautification filter on the target object in the at least one material based on the beautification related instruction), and then in response to a selection, by the user, of a target beautification processing result in the at least one beautification processing result, the material editing robot applies beautification filter on the target object in the target material in the at least one material based on a beautification parameter corresponding to the target beautification processing result. In addition, the material editing robot may store the beautification parameter corresponding to the target beautification processing result for subsequent use.

In some embodiments of the present disclosure, while the at least one beautification processing result is presented in the chat interface, at least one operation label may further be presented, and each operation label is used to indicate any one of the following: saving the target beautification processing result in the at least one beautification processing result; posting the target beautification processing result in the at least one beautification processing result to a publication interface of any social application; saving the beautification parameter corresponding to the target beautification processing result in the at least one beautification processing result; applying beautification filter on the target object in the target material again to generate a beautification processing result; and jumping to a video editing application to perform secondary editing on the at least one beautification processing result. In this way, the user can select a required operation label from the at least one operation label to perform corresponding processing on the target beautification processing result, thereby improving the user experience.

In some embodiments of the present disclosure, step 103 may be specifically implemented by the following step 103c.

103c: Present, in the chat interface, a target chat message replied by the material editing robot.

The target chat message includes the at least one material editing result, and the target chat message further includes at least one of the following: at least one operation identification or second prompt information.

Each operation identification is used to indicate any one of the following: playing a target material editing result in the at least one material editing result, saving the target material editing result in the at least one material editing result, posting the target material editing result in the at least one material editing result to an information publication interface of a second social application, re-editing on the target material to generate the material editing result, and jumping to a video editing application to perform a secondary editing on the target material editing result in the at least one material editing result; and the second prompt information is used to prompt the user that the at least one material editing result has been generated.

The target material editing result may be one material editing result or a plurality of material editing results in the at least one material editing result. The specific result may be determined based on a requirement of the user, which is not limited here.

The second social application may be the first social application, or another social application except for the first social application. The specific application may be determined based on an actual situation.

If the at least one operation identification includes a target operation identification corresponding to “posting the target material editing result in the at least one material editing result to the information publication interface of the second social application”, the target operation identification is associated with path information for jumping to the information publication interface.

If the second social application is the same as the first social application, the chat interface may be an interface in a private domain of the first social application, and the information publication interface may be an interface in a public domain of the first social application. In this way, conversion from the private domain to the public domain, for example, conversion from private domain operation to public domain operation can be implemented through the target identification, thereby increasing an operation manner of the target service.

The video editing application may be any application with a material editing function. The specific application may be determined based on an actual situation, which is not limited here.

The user prompted by the second prompt information may be any first user, may be the second user, or may be the user who sends the material editing instruction. The specific user may be determined based on an actual situation, which is not limited here.

Specific text content of the second prompt information may be “The video is ready. Come and have a look”, “@First user, the video is ready. Come and have a look”, “@First user, the video is ready. Come and have a look at how beautiful it is” or the like. The specific content may be determined based on an actual situation, which is not limited here.

In the embodiments of the present disclosure, by presenting the at least one operation identification while presenting the at least one material editing result, it is convenient for the user to select a required operation identification from the at least one operation identification to perform corresponding processing on the at least one material editing result; and by presenting the second prompt information while presenting the at least one material editing result, it is convenient for the user to quickly determine that an edited video has been made, thereby improving the user experience.

In some embodiments of the present disclosure, after step 103c, the method for material editing provided in the embodiments of the present disclosure may further include the following step 104.

104: Present, in the chat interface, a first chat message between the first user and the second user.

The first chat message includes at least one of the following: a discussion message about an editing effect of the at least one material editing result; a discussion message about the target service based on the at least one material editing result; or a discussion message about posting the at least one material editing result to an information publication interface of a second social application.

The first chat message may be a chat message between any first user and the second user. The specific chat message may be determined based on an actual situation, which is not limited here.

If the first chat message includes the discussion message about the editing effect of the at least one material editing result, for example, the target object is the second user, the first chat message may specifically include: the first user saying to the second user “@Second user, come and have a look at the editing effect. If you are not satisfied, it can be redone”, “@Second user, come and have a look at the editing effect. I think it is very good”, or the like; and the second user replying to the first user “The editing effect is very good. Details are edited out and I am beautiful”, “The robot edits very well, and the beautification filter is also suitable for me”, “I think the third one is good, that is . . . ”, “I think the effect is not good. Redo it”, or the like. The specific content may be determined based on an actual situation, which is not limited here.

If the first chat message includes the discussion message about the target service based on the at least one material editing result, for example, the target object is the second user, the first chat message may specifically include: the second user saying to the first user “@First user, your service is very good, and the more I look at it, the more I think your service is very meticulous”, “@First user, only your good service can edit out such a beautiful video and can make me so beautiful”, or the like; and the first user replying to the second user “Thank you for your compliment”, “It is my honor to serve you”, or the like. The specific content may be determined based on an actual situation, which is not limited here.

If the first chat message includes the discussion message about posting the at least one material editing result to the information publication interface of the second social application, for example, the target object is the second user, the first chat message may specifically include: the first user saying to the second user “@Second user, if you are satisfied with the editing effect, you can click the target operation identification to forward it”, “@Second user, you can click the target operation identification to forward the material editing result that you are satisfied with”, or the like; and the second user replying to the first user “OK”, “OK. I want everyone to have a look . . . ”, or the like. The specific content may be determined based on an actual situation, which is not limited here.

The first chat message may further include a message with other content. The specific content may be determined based on an actual situation, which is not limited here.

It should be noted that in the embodiments of the present disclosure, it is not limited whether the first chat message is initiated by the first user or the second user. The specific initiator may be determined based on an actual situation.

In the embodiments of the present disclosure, the first user and the second user can discuss the editing effect of the at least one material editing result through chatting; can discuss the target service based on the at least one material editing result through chatting; or can discuss whether to post the at least one material editing result to the information publication interface of the second social application through chatting; so that the first user can strengthen operation management on the target service by using the target chat.

In some embodiments of the present disclosure, after step 103c, the method for material editing provided in the embodiments of the present disclosure may further include the following step 105.

105: Present third prompt information in the chat interface.

The third prompt information is used to indicate that a third user joins the target chat by using link information carried in the target material editing result posted by a second user on the information publication interface.

The target material editing result further carries at least one of the following: related text information of the target material editing result, location information corresponding to the target service, or service type information of the target service; and the link information is used to indicate a path for joining the target chat.

Specific content of the third prompt information may be determined based on an actual situation, which is not limited here.

The related text information of the target material editing result, the location information corresponding to the target service, the service type information of the target service, and the link information are all information carried in the posted target material editing result.

In some embodiments of the present disclosure, the second user may join the target chat by using information associated with the link information that is posted by another user on the information publication interface, or may join the target chat by scanning a two-dimensional code given by the first user after experiencing the service in a store, or may be pulled into the target chat by the first user after becoming a friend of the first user. The specific manner may be determined based on an actual situation, which is not limited here.

The related text information is used to introduce the target material editing result and may specifically introduce the target service presented in the target material editing result, a geographic location of the target service presented in the target material editing result, the first user who provides the target service presented in the target material editing result, or the like. The specific content may be determined based on an actual situation, which is not limited here.

The location information is used to indicate a location corresponding to the target service, for example, a geographic location of a store that provides the target service, a name of the store that provides the target service, or the like. The specific location may be determined based on an actual situation, which is not limited here.

The service type information is used to indicate a type to which the target service belongs. For example, service type information about the target service is “hair cutting”.

The link information is used to indicate a manner or a path for joining the target chat. The link information may include, for example, two-dimensional code information corresponding to the target chat, or may include, for example, name information corresponding to the target chat. The specific information may be determined based on an actual situation, which is not limited here.

In the embodiments of the present disclosure, the user is prompted through the third prompt information that a new user joins the target chat and a manner by which the new user joins the target chat, so that the user experience can be improved.

In some embodiments of the present disclosure, the third user has permission to view a historical chat record of the target chat. After step 105, the method for material editing provided in the embodiments of the present disclosure may further include the following step 106.

106: Present, in the chat interface, a second chat message between the third user and a fourth user.

The second chat message includes a discussion message about the target service based on the at least one material editing result, and the fourth user includes any one of the following: the first user and the second user.

The discussion message about the target service based on the at least one material editing result may include discussion about information such as an effect and a required duration of the target service.

For example, the second chat message may include: the third user saying to the second user “@Second user, the effect of the target service is good, right?”, “@Second user, look at the material editing result above. Do you think the quality of the target service is good?”, “@Second user, how is your service experience?”, or the like; and the second user replying to the third user “Yes, it is good!”, “Recommend you try it”, or the like. The specific content may be determined based on an actual situation, which is not limited here.

For example, the second chat message may include: the third user saying to the first user “@First user, how long does it take to achieve a service effect in the first material editing result?”, “@First user, I also want a service effect of . . . in the second material editing result”, or the like; and the first user replying to the third user “It takes . . . time”, “OK! Welcome to experience the service in the store at any time”, or the like. The specific content may be determined based on an actual situation, which is not limited here.

It should be noted that in the embodiments of the present disclosure, it is not limited whether the second chat message is initiated by the third user or the fourth user. The specific initiator may be determined based on an actual situation.

In some embodiments of the present disclosure, the foregoing second chat message may also be a chat message between the first user, the second user, and the third user. The specific chat message may be determined based on an actual situation.

In the embodiments of the present disclosure, the third user and the fourth user can discuss the target service based on the at least one material editing result through chatting, so that the third user can have an in-depth understanding of the target service. Particularly, when the second chat message is a chat message between the third user and the second user, since the second user has really experienced the target service, a comment of the second user on the quality of the target service can be more convincing to the third user, so that the user experience can be improved, and an effect of operation management on the target service by using the target chat can be improved.

In some embodiments of the present disclosure, after the third user joins the target chat and has an understanding of the target service, the third user may experience the target service in a store. Therefore, the user can send, in the target chat, a material of the third user experiencing the target service, and then the material editing robot can generate a material editing result corresponding to the third user based on the material of the third user experiencing the target service. Then, the third user may also post the material editing result corresponding to the third user to the information publication interface, and another user may also join the target chat by using link information carried in the material editing result posted by the third user. In this way, posting of the material editing result corresponding to the target service by each user who joins the target chat can attract more users to join the target chat, so that efficiency of operation management on the target service by using the target chat can be improved.

In some embodiments of the present disclosure, before step 105, the method for material editing provided in the embodiments of the present disclosure may further include the following step 107.

107: Present fourth prompt information in the chat interface.

The fourth prompt information is used to indicate that the second user posts the target material editing result to the information publication interface.

Specific content of the fourth prompt information may be determined based on an actual situation, which is not limited here.

In the embodiments of the present disclosure, the second user is prompted through the fourth prompt information that the target material editing result is forwarded, so that the first user and other users can clearly know which user forwards the material editing result, thereby facilitating improvement of the user experience. According to the fourth prompt information, the user experience can be improved, and an effect of operation management on the target service by using the target chat can be improved.

It should be noted that the related description content about the chat interface in steps 101 to 107 is displayed in an electronic device corresponding to each user in the target chat. Therefore, it is not distinguished which user's electronic device presents the chat interface in steps 101 to 107.

In some embodiments of the present disclosure, the electronic device is an electronic device of the second user. Before step 105, the method for material editing provided in the embodiments of the present disclosure may further include the following steps 108 and 109.

108: Present an information confirmation interface in response to a triggering operation of the second user on a target operation identification in the at least one operation identification.

The information confirmation interface is used to confirm information carried in the target material editing result, and the target operation identification is used to indicate the posting of the target material editing result to the information publication interface.

The information carried in the target material editing result may be input by the second user to the information confirmation interface through an operation or may be automatically generated. The specific information may be determined based on an actual situation, which is not limited here.

In some embodiments of the present disclosure, if the information carried in the target material editing result is automatically generated, an operation process of forwarding the target material editing result can be simplified, an operation difficulty can be reduced, a requirement for the user can be reduced, the user experience can be improved, and input errors of the user can be avoided, so that accuracy of forwarding can be improved.

109: Present the target material editing result and the information carried in the target material editing result on the information publication interface in response to the triggering operation of the second user confirming to post the target material editing result.

In the embodiments of the present disclosure, posting of the target material editing result can be implemented by the foregoing steps 108 and 109. The operation process is simple and easy to implement, and the user experience can be improved.

In some embodiments of the present disclosure, after step 109, the material editing method provided in the embodiments of the present disclosure may further include the following step 110.

110: Present a first resource information interface.

The first resource information interface is used to present a resource obtained by the second user because of posting the target material editing result, the first resource information interface includes first resource information and second resource information, the first resource information is used to indicate a resource allocated to the second user because of a first-type user who joins the target chat by using the link information, and the second resource information is used to indicate a resource to be allocated to the second user because of a second-type user who joins the target chat by using the link information, where the first-type user is a user who has accepted the target service provided by the first user, and the second-type user is a user who has not accepted the target service provided by the first user.

The first resource information interface may further include other content. The specific content may be determined based on an actual situation, which is not limited here.

In some embodiments of the present disclosure, the electronic device is an electronic device of the first user, and the method for material editing provided in the embodiments of the present disclosure may further include the following step 111.

111: Present a second resource information interface.

The second resource information interface is used to present a resource obtained by performing operation management on the target service by using the target chat, and the second resource information interface includes first resource information, second resource information, and third resource information.

The first resource information is used to indicate a resource allocated to the second user because of a first-type user who joins the target chat by using the link information, the second resource information is used to indicate a resource to be allocated to the second user because of a second-type user who joins the target chat by using the link information, and the third resource information is used to indicate a resource obtained for providing the target service for the first-type user who joins the target chat by using the link information, where the first-type user is a user who has accepted the target service provided by the first user, and the second-type user is a user who has not accepted the target service provided by the first user.

The second resource information interface may further include other content. The specific content may be determined based on an actual situation, which is not limited here.

In some embodiments of the present disclosure, after the third user joins the target chat by using the link information carried in the target material editing result and accepts the target service provided by the first user, the first user can obtain, from the third user, a target resource equivalent to the target service. Since the third user joins the target chat by using the link information carried in the target material editing result, before the third user accepts the target service provided by the first user, the resource to be obtained by the corresponding second user because of the third user is presented in the second resource information; and after the third user accepts the target service provided by the first user, the resource obtained by the corresponding second user because of the third user is presented in the first resource information. The resource to be obtained by the second user because of the third user is the same as the resource obtained by the second user because of the third user, and the resource to be obtained by the second user because of the third user is a part of the target resource that should be allocated to the second user.

In the embodiments of the present disclosure, after the second user posts the target material editing result, the second user can determine, through the first resource information interface, the resource obtained by the second user for posting the target material editing result, and the first user can determine, through the second resource information interface, the resource obtained through operation management on the target service by using the target chat. In this way, efficiency of operation management on the target service by using the target chat can be improved, and the user experience can be improved.

In some embodiments of the present disclosure, before step 101, the material editing method provided in the embodiments of the present disclosure may further include the following steps 112 and 113.

112: Present a function setting interface of the material editing robot in response to a triggering operation in which the first user adds the material editing robot to the target chat.

On the function setting interface, information such as a nickname of the material editing robot, a function definition, service type information about the target service, location information about providing the target service, and whether the material editing robot is visible to all users may be set. The specific information may be determined based on an actual situation, which is not limited here.

The information that needs to be set in the function setting interface may be information that must be set or information that can be selectively set. The specific information may be determined based on an actual situation, which is not limited here.

113: in response to a triggering operation of the first user on the function setting interface, present a chat message sent by the material editing robot in the chat interface.

The chat message includes a function introduction of the material editing robot in text form, and the chat message further includes at least one of the following: a function introduction of the material editing robot in video form; or a question from the material editing robot on a chat topic of the chat interface.

In the embodiments of the present disclosure, the first user may add the material editing robot to the target chat by using an operation of adding a chat member in a process of creating the target chat or may add the material editing robot to the target chat by using the operation of adding the chat member in the target chat after creating the target chat. The specific manner may be determined based on an actual situation, which is not limited here.

The chat topic may include a topic of a different service type or may include a topic other than the service type. The specific topic may be determined based on an actual situation, which is not limited here.

In some embodiments of the present disclosure, the question from the material editing robot on a chat topic of the chat interface may present a plurality of chat topic options for the user to select and may further include a “no topic” option. The specific options may be determined based on an actual situation, which is not limited here.

In some embodiments of the present disclosure, the second user may also select to post a material editing result of another user experiencing the target service to the information publication interface. The specific operation may be agreed with the first user, which is not limited here.

In some embodiments of the present disclosure, the first user may further send a preferential activity related to the target service and incentive content for posting the material editing result (for example, there is a discount for the target service, and another user can obtain a specific resource by experiencing the target service based on the posted material editing result) in the target chat. The specific content may be determined based on an actual situation, which is not limited here.

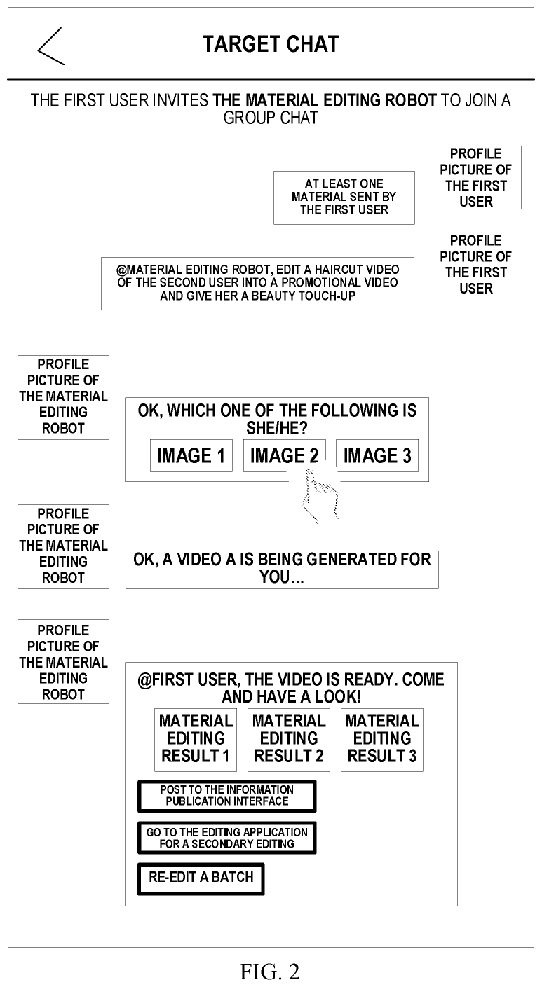

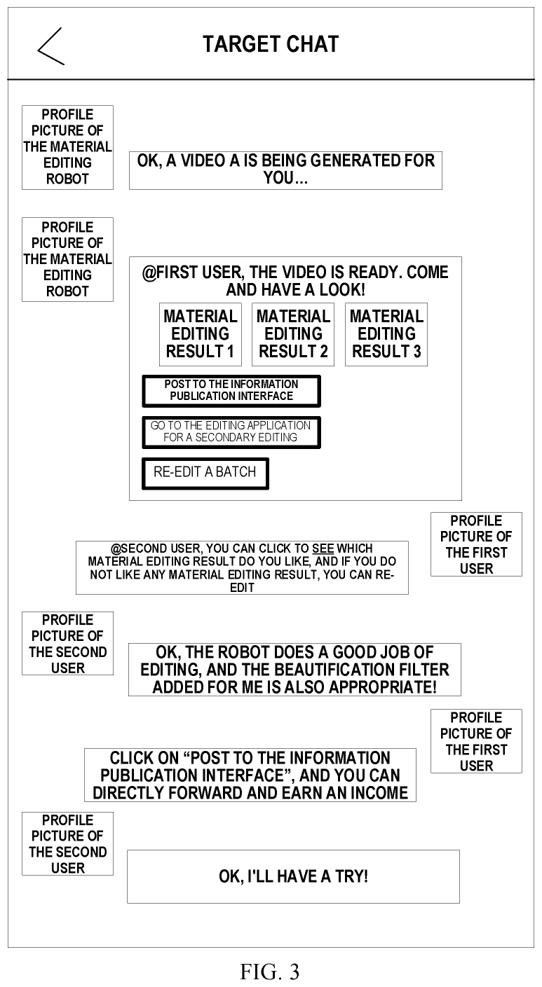

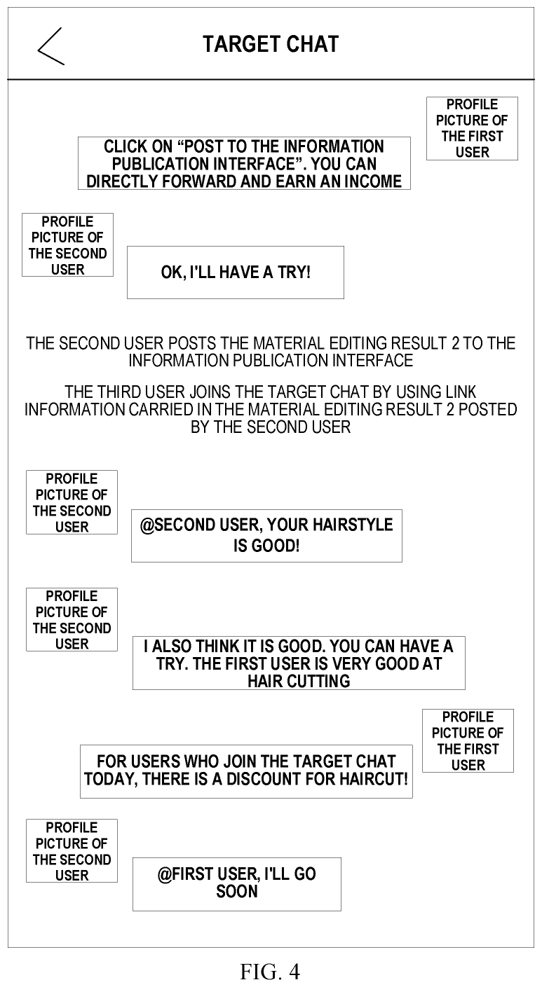

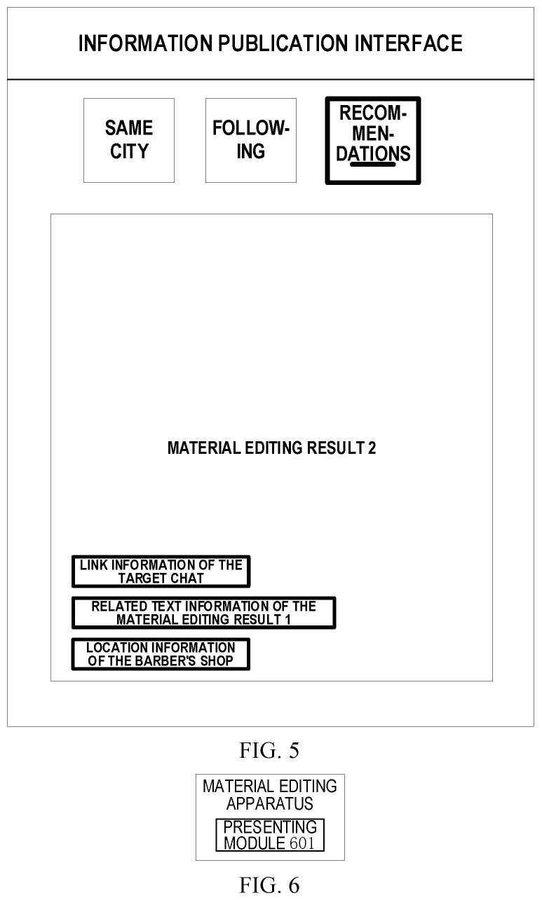

For example, FIG. 2 is a schematic diagram of the first user sending the material editing instruction to the material editing robot in the target chat, and the material editing robot replying to three material editing results in response to the material editing instruction. FIG. 3 is a schematic diagram of a first chat message between the first user and the second user based on the three material editing results. FIG. 4 is a schematic diagram of a second chat message between the third user and the second user and the first user after the third user joins the target chat by using link information carried in a material editing result 2 posted by the second user. FIG. 5 is a schematic diagram of the material editing result 2 posted by the second user on the information publication interface. For details, refer to information presented in the figure. Details are not described herein again.

In the embodiments of the present disclosure, by adding the material editing robot to the target chat and performing chat-based creation of a video, a creation threshold for the user to perform material editing can be reduced, and the user can quickly get started with creation without understanding an editing product. In addition, efficiency of operation management on the target service by the user in the target chat can be improved, the enthusiasm of the user for operation management on the target service by using the target chat can be improved, the willingness of the user to perform instant social communication and exchange by using the first social application can be improved, and group chat activity of the target chat can be improved.

FIG. 6 is a block diagram of a structure of an apparatus for material editing according to an embodiment of the present disclosure. As shown in FIG. 6, the apparatus includes: a presenting module 601, configured to present a chat interface of a target chat in a first social application, where the target chat is used for operation management of a target service, and members of the target chat include a material editing robot, at least one first user, and at least one second user, where at least one material is presented in the chat interface, the at least one material being used to indicate a process in which the first user provides the target service for a target object, and the target object is an object related to the second user; present, in the chat interface, a material editing instruction for the target object that is sent by a user to the material editing robot; and present, in the chat interface, at least one material editing result replied by the material editing robot, where the at least one material editing result is obtained by the material editing robot through performing editing on a target material in the at least one material based on the material editing instruction, and each material editing result is used to indicate a service process and a service effect of the target service for the target object.

In some embodiments of the present disclosure, the presenting module is specifically configured to present, in the chat interface, a plurality of images and first prompt information replied by the material editing robot, where the first prompt information is used to prompt the user to select, from the plurality of images, an image corresponding to the target object, and each image is an image that includes one object extracted by the material editing robot from the at least one material; and present the at least one material editing result in response to a triggering operation in which the user selects a target image corresponding to the target object.

In some embodiments of the present disclosure, the presenting module is specifically configured to present, in the chat interface, a target chat message replied by the material editing robot, where the target chat message includes the at least one material editing result, and the target chat message further includes at least one of the following: at least one operation identification or second prompt information; where each operation identification is used to indicate any one of the following: playing a target material editing result in the at least one material editing result, saving the target material editing result in the at least one material editing result, posting the target material editing result in the at least one material editing result to an information publication interface of a second social application, re-editing on the target material to generate the material editing result, and jumping to a video editing application to perform a secondary editing on the target material editing result in the at least one material editing result; and the second prompt information is used to prompt the user that the at least one material editing result has been generated.

In some embodiments of the present disclosure, the presenting module is further configured to present, in the chat interface, a first chat message between the first user and the second user, where the first chat message includes at least one of the following: a discussion message about an editing effect of the at least one material editing result; a discussion message about the target service based on the at least one material editing result; or a discussion message about posting the at least one material editing result to an information publication interface of a second social application.

In some embodiments of the present disclosure, the presenting module is further configured to present third prompt information in the chat interface, where the third prompt information is used to indicate that a third user joins the target chat by using link information carried in the target material editing result posted by a second user on the information publication interface, where the target material editing result further carries at least one of the following: related text information of the target material editing result, location information corresponding to the target service, or service type information of the target service; and the link information is used to indicate a path for joining the target chat.

In some embodiments of the present disclosure, the third user has permission to view a historical chat record of the target chat; and the presenting module is further configured to present, in the chat interface, a second chat message between the third user and a fourth user, where the second chat message includes: a discussion message about the target service based on the at least one material editing result, and the fourth user includes any one of the following: the first user and the second user.

In some embodiments of the present disclosure, the presenting module is further configured to present fourth prompt information in the chat interface, where the fourth prompt information is used to indicate that the second user posts the target material editing result to the information publication interface.

In some embodiments of the present disclosure, the electronic device is an electronic device of the second user, and the presenting module is further configured to present an information confirmation interface in response to a triggering operation of the second user on a target operation identification in the at least one operation identification, where the information confirmation interface is used to confirm information carried in the target material editing result, and the target operation identification is used to indicate the posting of the target material editing result to the information publication interface; and present the target material editing result and the information carried in the target material editing result on the information publication interface in response to the triggering operation of the second user confirming to post the target material editing result.

In some embodiments of the present disclosure, the presenting module is further configured to present a first resource information interface, where the first resource information interface is used to present a resource obtained by the second user because of posting the target material editing result, and the first resource information interface includes first resource information and second resource information, the first resource information is used to indicate a resource allocated to the second user because of a first-type user who joins the target chat by using the link information, and the second resource information is used to indicate a resource to be allocated to the second user because of a second-type user who joins the target chat by using the link information, where the first-type user is a user who has accepted the target service provided by the first user, and the second-type user is a user who has not accepted the target service provided by the first user.

In some embodiments of the present disclosure, the electronic device is an electronic device of the first user, and the presenting module is further configured to present a second resource information interface, where the second resource information interface is used to present a resource obtained by performing operation management on the target service by using the target chat, and the second resource information interface includes first resource information, second resource information, and third resource information; where the first resource information is used to indicate a resource allocated to the second user because of a first-type user who joins the target chat by using the link information, the second resource information is used to indicate a resource to be allocated to the second user because of a second-type user who joins the target chat by using the link information, and the third resource information is used to indicate a resource obtained by providing the target service for the first-type user who joins the target chat by using the link information, where the first-type user is a user who has accepted the target service provided by the first user, and the second-type user is a user who has not accepted the target service provided by the first user.

In some embodiments of the present disclosure, the presenting module is further configured to present a function setting interface of the material editing robot in response to a triggering operation in which the first user adds the material editing robot to the target chat; and in response to a triggering operation of the first user on the function setting interface, presenting a chat message sent by the material editing robot in the chat interface; where the chat message includes a function introduction of the material editing robot in text form, and the chat message further includes at least one of the following: a function introduction of the material editing robot in video format; or a question from the material editing robot on a chat topic of the chat interface.

In the embodiments of the present disclosure, each module can implement the method for material editing provided in the foregoing method embodiments and can achieve the same technical effect. To avoid repetition, details are not described herein again.

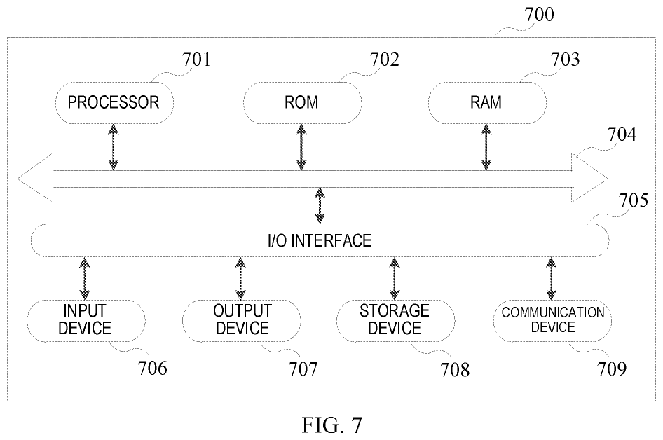

FIG. 7 is a schematic diagram of a structure of an electronic device according to an embodiment of the present disclosure and is used to exemplarily illustrate an electronic device that implements any method for material editing in the embodiments of the present disclosure and should not be construed as a specific limitation on the embodiments of the present disclosure.

As shown in FIG. 7, an electronic device 700 may include a processor (for example, a central processor, a graphics processor, or the like) 701 that may perform a variety of appropriate actions and processing in accordance with a program stored in a read-only memory (ROM) 702 or a program loaded from a storage device 708 into a random-access memory (RAM) 703. The RAM 703 further stores various programs and data required for the operation of the electronic device 700. The processor 701, the ROM 702, and the RAM 703 are connected to each other through a bus 704. An input/output (I/O) interface 705 is also connected to the bus 704.

Generally, the following apparatuses may be connected to the I/O interface 705: an input device 706 including, for example, a touch screen, a touchpad, a keyboard, a mouse, a camera, a microphone, an accelerometer, and a gyroscope; an output device 707 including, for example, a liquid crystal display (LCD), a speaker, and a vibrator; the storage device 708 including, for example, a tape and a hard disk; and a communication device 709. The communication device 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication device 709, or installed from the storage device 708, or installed from the ROM 702. When the computer program is executed by the processor 701, the functions defined in the material editing method according to any one of the embodiments of the present disclosure may be performed.

It should be noted that the foregoing computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), or the like, or any suitable combination thereof.

In some implementations, the client and the server may communicate by using any currently known or future-developed network protocol such as a hypertext transfer protocol (HTTP) and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The computer-readable medium carries one or more programs that, when executed by the electronic device, cause the electronic device to: present a chat interface of a target chat in a first social application, where the target chat is used for operation management on a target service, members of the target chat include a material editing robot, at least one first user, and a second user, at least one material is presented in the chat interface, the at least one material is used to indicate a process of a first user providing the target service for a target object, and the target object is an object related to the second user; present, in the chat interface, a material editing instruction for the target object that is sent by a user to the material editing robot; and present, in the chat interface, at least one material editing result replied by the material editing robot, where the at least one material editing result is obtained by the material editing robot based on the material editing instruction by performing editing on a target material in the at least one material, and each material editing result is used to indicate a service process and a service effect of the target service for the target object.

In the embodiments of the present disclosure, computer program code for performing operations of the present disclosure may be written in one or more programming languages or a combination thereof, where the programming languages include but are not limited to an object-oriented programming language such as Java, Smalltalk, and C++, and further include conventional procedural programming languages such as “C” language or similar programming languages. The program code may be completely executed on a computer, partially executed on a computer, executed as an independent software package, partially executed on a computer and partially executed on a remote computer, or completely executed on a remote computer or a server. In the case involving a remote computer, the remote computer may be connected to the computer through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations or may be implemented by a combination of dedicated hardware and computer instructions.

The related units described in the embodiments of the present disclosure may be implemented by means of software or may be implemented by means of hardware. The name of a unit does not constitute a limitation on the unit in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a computer-readable medium may be a tangible medium that may contain or store a program for use by or in combination with an instruction execution system, apparatus, or device. The computer-readable medium may be a computer-readable signal medium or a computer-readable storage medium. The computer-readable medium may include, but is not limited to, electronic, magnetic, optical, electromagnetic, infrared, or semiconductor systems, apparatuses, or devices, or any suitable combination thereof. More specific examples of the computer-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. A person skilled in the art should understand that the scope of disclosure involved in the present disclosure is not limited to the technical solutions formed by a specific combination of the foregoing technical features and shall also cover other technical solutions formed by any combination of the foregoing technical features or equivalent features thereof without departing from the foregoing concept of disclosure. For example, a technical solution formed by replacing the foregoing features with technical features (but not limited to) with similar functions disclosed in the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A method for material editing, applied to an electronic device, comprising:
presenting a chat interface of a target chat in a first social application, wherein the target chat is used for operation management of a target service, and members of the target chat comprise a material editing robot, at least one first user, and at least one second user, wherein at least one material is presented in the chat interface, the at least one material being used to indicate a process in which the first user provides the target service for a target object, and the target object is an object related to the second user;
presenting, in the chat interface, a material editing instruction for the target object that is sent by a user to the material editing robot; and
presenting, in the chat interface, at least one material editing result replied by the material editing robot, wherein the at least one material editing result is obtained by the material editing robot through performing editing on a target material in the at least one material based on the material editing instruction, and each material editing result is used to indicate a service process and a service effect of the target service for the target object.

2. The method of claim 1, wherein the presenting, in the chat interface, at least one material editing result replied by the material editing robot comprises:
presenting, in the chat interface, a plurality of images and first prompt information replied by the material editing robot, wherein the first prompt information is used to prompt the user to select, from the plurality of images, an image corresponding to the target object, and each image is an image that includes one object extracted by the material editing robot from the at least one material; and
presenting the at least one material editing result in response to a triggering operation in which the user selects a target image corresponding to the target object.

3. The method of claim 1, wherein the presenting, in the chat interface, at least one material editing result replied by the material editing robot comprises:
presenting, in the chat interface, a target chat message replied by the material editing robot, wherein the target chat message comprises the at least one material editing result, and the target chat message further comprises at least one of the following: at least one operation identification or second prompt information,
wherein each operation identification is used to indicate any one of the following: playing a target material editing result in the at least one material editing result, saving the target material editing result in the at least one material editing result, posting the target material editing result in the at least one material editing result to an information publication interface of a second social application, re-editing on the target material to generate the material editing result, and jumping to a video editing application to perform a secondary editing on the target material editing result in the at least one material editing result; and
the second prompt information is used to prompt the user that the at least one material editing result has been generated.

4. The method of claim 3, wherein after the presenting, in the chat interface, the target chat message replied by the material editing robot, the method further comprises:
presenting, in the chat interface, a first chat message between the first user and the second user,
wherein the first chat message comprises at least one of the following:
a discussion message about an editing effect of the at least one material editing result;
a discussion message about the target service based on the at least one material editing result; or
a discussion message about posting the at least one material editing result to an information publication interface of a second social application.

5. The method of claim 3, wherein after the presenting, in the chat interface, a target chat message replied by the material editing robot, the method further comprises:
presenting third prompt information in the chat interface, wherein the third prompt information is used to indicate that a third user joins the target chat by using link information carried in the target material editing result posted by a second user on the information publication interface,
wherein the target material editing result further carries at least one of the following: related text information of the target material editing result, location information corresponding to the target service, or service type information of the target service; and the link information is used to indicate a path for joining the target chat.

6. The method of claim 5, wherein the third user has permission to view a historical chat record of the target chat; and after the presenting third prompt information in the chat interface, the method further comprises:
presenting, in the chat interface, a second chat message between the third user and a fourth user,
wherein the second chat message comprises: a discussion message about the target service based on the at least one material editing result, and the fourth user comprises any one of the following: the first user and the second user.

7. The method of claim 5, wherein before the presenting third prompt information in the chat interface, the method further comprises:
presenting fourth prompt information in the chat interface, wherein the fourth prompt information is used to indicate that the second user posts the target material editing result to the information posting interface.

8. The method of claim 5, wherein the electronic device is an electronic device of the second user, and before the presenting third prompt information in the chat interface, the method further comprises:
presenting an information confirmation interface in response to a triggering operation of the second user on a target operation identification in the at least one operation identification, wherein the information confirmation interface is used to confirm information carried in the target material editing result, and the target operation identification is used to indicate the posting of the target material editing result to the information publication interface; and
presenting the target material editing result and the information carried in the target material editing result on the information publication interface in response to the triggering operation of the second user confirming to post the target material editing result.

9. The method of claim 8, wherein after the presenting the target material editing result and the information carried in the target material editing result on the information publication interface in response to the triggering operation of the second user confirming to post the target material editing result, the method further comprises:
presenting a first resource information interface, wherein the first resource information interface is used to present a resource obtained by the second user because of posting the target material editing result, and the first resource information interface comprises first resource information and second resource information, the first resource information is used to indicate a resource allocated to the second user because of a first-type user who joins the target chat by using the link information, and the second resource information is used to indicate a resource to be allocated to the second user because of a second-type user who joins the target chat by using the link information, wherein the first-type user is a user who has accepted the target service provided by the first user, and the second-type user is a user who has not accepted the target service provided by the first user.

10. The method of claim 5, wherein the electronic device is an electronic device of the first user, and the method further comprises:
presenting a second resource information interface, wherein the second resource information interface is used to present a resource obtained by performing operation management on the target service by using the target chat, and the second resource information interface comprises first resource information, second resource information, and third resource information,
wherein the first resource information is used to indicate a resource allocated to the second user because of a first-type user who joins the target chat by using the link information, the second resource information is used to indicate a resource to be allocated to the second user because of a second-type user who joins the target chat by using the link information, and the third resource information is used to indicate a resource obtained by providing the target service for the first-type user who joins the target chat by using the link information, wherein the first-type user is a user who has accepted the target service provided by the first user, and the second-type user is a user who has not accepted the target service provided by the first user.

11. The method of claim 10, wherein before the presenting, the chat interface of the target chat in the first social application, the method further comprises:
presenting a function setting interface of the material editing robot in response to a triggering operation in which the first user adds the material editing robot to the target chat; and
in response to a triggering operation of the first user on the function setting interface, presenting a chat message sent by the material editing robot in the chat interface,
wherein the chat message comprises a function introduction of the material editing robot in text form, and the chat message further comprises at least one of the following:
a function introduction of the material editing robot in video format; or
a question from the material editing robot on a chat topic of the chat interface.

12. An electronic device, comprising: a memory and a processor, wherein the memory is configured to store a computer program which, when executed by the processor, causing the electronic device to implement a method for material editing, comprising:
presenting a chat interface of a target chat in a first social application, wherein the target chat is used for operation management of a target service, and members of the target chat comprise a material editing robot, at least one first user, and at least one second user, wherein at least one material is presented in the chat interface, the at least one material being used to indicate a process in which the first user provides the target service for a target object, and the target object is an object related to the second user;
presenting, in the chat interface, a material editing instruction for the target object that is sent by a user to the material editing robot; and
presenting, in the chat interface, at least one material editing result replied by the material editing robot, wherein the at least one material editing result is obtained by the material editing robot through performing editing on a target material in the at least one material based on the material editing instruction, and each material editing result is used to indicate a service process and a service effect of the target service for the target object.

13. The electronic device of claim 12, wherein the presenting, in the chat interface, at least one material editing result replied by the material editing robot comprises:
presenting, in the chat interface, a plurality of images and first prompt information replied by the material editing robot, wherein the first prompt information is used to prompt the user to select, from the plurality of images, an image corresponding to the target object, and each image is an image that includes one object extracted by the material editing robot from the at least one material; and
presenting the at least one material editing result in response to a triggering operation in which the user selects a target image corresponding to the target object.

14. The electronic device of claim 12, wherein the presenting, in the chat interface, at least one material editing result replied by the material editing robot comprises:
presenting, in the chat interface, a target chat message replied by the material editing robot, wherein the target chat message comprises the at least one material editing result, and the target chat message further comprises at least one of the following: at least one operation identification or second prompt information,
wherein each operation identification is used to indicate any one of the following: playing a target material editing result in the at least one material editing result, saving the target material editing result in the at least one material editing result, posting the target material editing result in the at least one material editing result to an information publication interface of a second social application, re-editing on the target material to generate the material editing result, and jumping to a video editing application to perform a secondary editing on the target material editing result in the at least one material editing result; and
the second prompt information is used to prompt the user that the at least one material editing result has been generated.

15. The electronic device of claim 14, wherein after the presenting, in the chat interface, the target chat message replied by the material editing robot, the method further comprises:
presenting, in the chat interface, a first chat message between the first user and the second user,
wherein the first chat message comprises at least one of the following:
a discussion message about an editing effect of the at least one material editing result;
a discussion message about the target service based on the at least one material editing result; or
a discussion message about posting the at least one material editing result to an information publication interface of a second social application.

16. The electronic device of claim 14, wherein after the presenting, in the chat interface, a target chat message replied by the material editing robot, the method further comprises:
presenting third prompt information in the chat interface, wherein the third prompt information is used to indicate that a third user joins the target chat by using link information carried in the target material editing result posted by a second user on the information publication interface,
wherein the target material editing result further carries at least one of the following: related text information of the target material editing result, location information corresponding to the target service, or service type information of the target service; and the link information is used to indicate a path for joining the target chat.

17. The electronic device of claim 16, wherein the third user has permission to view a historical chat record of the target chat; and after the presenting third prompt information in the chat interface, the method further comprises:
presenting, in the chat interface, a second chat message between the third user and a fourth user,
wherein the second chat message comprises: a discussion message about the target service based on the at least one material editing result, and the fourth user comprises any one of the following: the first user and the second user.

18. The electronic device of claim 16, wherein before the presenting third prompt information in the chat interface, the method further comprises:
presenting fourth prompt information in the chat interface, wherein the fourth prompt information is used to indicate that the second user posts the target material editing result to the information publication interface.

19. The electronic device of claim 16, wherein the electronic device is an electronic device of the second user, and before the presenting third prompt information in the chat interface, the method further comprises:
presenting an information confirmation interface in response to a triggering operation of the second user on a target operation identification in the at least one operation identification, wherein the information confirmation interface is used to confirm information carried in the target material editing result, and the target operation identification is used to indicate the posting of the target material editing result to the information publication interface; and
presenting the target material editing result and the information carried in the target material editing result on the information publication interface in response to the triggering operation of the second user confirming to post the target material editing result.

20. A non-transitory computer-readable storage medium, having a computer program stored thereon, that, when executed by a processor, implements a method for material editing, comprising:
presenting a chat interface of a target chat in a first social application, wherein the target chat is used for operation management of a target service, and members of the target chat comprise a material editing robot, at least one first user, and at least one second user, wherein at least one material is presented in the chat interface, the at least one material being used to indicate a process in which the first user provides the target service for a target object, and the target object is an object related to the second user;
presenting, in the chat interface, a material editing instruction for the target object that is sent by a user to the material editing robot; and
presenting, in the chat interface, at least one material editing result replied by the material editing robot, wherein the at least one material editing result is obtained by the material editing robot through performing editing on a target material in the at least one material based on the material editing instruction, and each material editing result is used to indicate a service process and a service effect of the target service for the target object.
